(19) United States
(12) Patent Application Publication
(10) Pub. No.: US 2011/0080136 A1
(43) Pub. Date: Apr. 7, 2011

(54) Power adaptor with backup battery charging function for portable computer

(76) Inventors: Mou-Ming Ma, Taipei (TW); Yi-Yuan Liu, Taipei (TW); Chien-Chih Kao, Taipei (TW)

(21) Appl. No.: 12/588,019

(22) Filed: Oct. 1, 2009

(51) Int. Cl. H02J 7/00

(52) U.S. Cl. 320/107

(57) ABSTRACT

A power adaptor for a portable computer includes housing, a first cord, a second cord, a power conversion circuit and a charging outlet. The first and second cords each extends from the housing. The first cord has a first connector for connection with an external power source while the second cord has a second connector for connection with a portable computer. The power conversion circuit is located inside the housing and has one end connected to the first cord and the other end to the second cord for conversing AC power from the external power source into DC power for the portable computer. The charging circuit located in the housing is connected to the power conversion circuit for charging a backup battery of the portable computer. The charging outlet is mounted on the housing and linked to the charging circuit for connection with the backup battery.

### BACKGROUND OF INVENTION

1. Field of Invention

This invention relates to a power adaptor for a portable computer and more particularly to a power adaptor capable of simultaneously providing power to the portable computer and charging an external backup battery.

2. Related Prior Art

Some portable computers include at least two rechargeable batteries which enable the computer to run without connection to an AC power source for a longer time. Typically, a host system of the portable computer is utilized to help charging a notebook battery, either a main battery or a backup battery. That is to say that the battery can't be charged without the computer. Therefore, when the backup battery charging is desired, the main battery which might be under use may have to be removed from the notebook computer for replacement of the backup battery. This causes great inconvenience for the users.

Known in the state of the art is a power adaptor for both car and indoor room use, as shown in Taiwan Pat. No. 210158. The power adaptor includes a main body, an AC power input port, a DC power input port and two power output ports. The power adaptor can power the portable computer and charge an inside main battery of the portable computer at the same time via the two power ports in order to decrease the use of a rechargeable battery. Apparently, there is no backup battery included in that patent. Moreover, the main battery has to be placed inside the notebook computer in order to be charged; and otherwise failed.

Another type of power adaptors, which is specifically presented for mobile phone, is shown in Taiwan Pat. Nos. M297047 and 1302776. The mobile phone adaptor can convert the AC power to DC power for mobile phone and include a battery socket for charging a secondary battery and a battery charging outlet for a lithium cell of the mobile phone. That is, the mobile phone adaptor can simultaneously charge the phone, the secondary battery and the lithium cell.

On the other hand, a multi-function battery charger is disclosed in Taiwan Pat. No. M244640, which integrates a charging circuit with different kinds of power lines to charge various electronic devices. The battery charger defines a battery socket therein to receive a rechargeable battery. Moreover, the battery charger cooperates with an adaptor which is mounted in a line outside the charger in order to output DC power for charging the rechargeable battery and then an electronic device if necessary. In cases where no external power source is available, the battery charger can further charge the electronic device by taking power from the rechargeable battery received in the battery socket.

Another battery charger disclosed in Taiwan Pat. No. M315446 includes a housing. Inside the housing is a battery socket, a first connector and a second connector. A user can selectively connect the first and second connectors to a battery charging outlet and a power input outlet of a portable computer respectively. Specifically, the battery charger is connected with an external power source via a converting circuit in such a way that the input AC power can be converted to DC power for charging a rechargeable battery which is received inside the battery socket. The power stored in the rechargeable battery can then be transferred to the electronic device. In this way, however, the efficiency of power transfer from the external source to the electronic device is relatively decreased.

### SUMMARY OF INVENTION

Broadly stated, the present invention is directed to a power adaptor for a portable computer. The power adaptor includes a housing, a first cord, a second cord, a power conversion circuit and a charging outlet. The first and second cords extend from opposite ends of the housing. The first cord has a first connector for connection with an external power source. The second cord has a connector for connection with the portable computer. The power conversion circuit is located in the housing and has one end connected to the first cord and the other end connected to the second cord. In addition, the power conversion circuit is configured for conversing AC power brought by the first cord into DC power and for transmitting the DC power to the portable computer via the second cord. The charging circuit is located in the housing, connected to the power conversion circuit and configured for charging a backup battery of the portable computer. The charging outlet is mounted on the housing and linked to the charging circuit for connection with the backup battery.

In this way, the power adaptor can converse AC to DC power and output it to the portable computer. When being linked to a wall outlet of a main power source, the power adaptor can transfer the conversed DC power to the portable computer, and at the same time charge a backup battery if it is connected to the charging outlet of the power adaptor. With the help of the power adaptor, the backup battery can be easily charged without the use of the host system of the portable computer.

In order to conform to different types of portable computers, the charging outlet of the power adaptor is configured in a fashion capable of being detached from the housing and replaced by another type of charge outlet. Therefore, the manufacturers can simply fabricate similar power adaptors, except different types of the charging outlets, to be in compliance with respective types of portable computers. On the other hand, a user may own a variety of portable computers which both can share one power adaptor by simply utilizing a variety of charging outlets.

The advantages of the present invention will be understood more readily after a consideration of the drawings and the Detailed Description.

### BRIEF DESCRIPTION OF DRAWINGS

The invention is illustrated by the accompanying drawings in which corresponding parts are identified by the same numerals and in which:

FIG. 1 is a perspective view of a power adaptor, shown to be connected with a portable computer, according to one embodiment of this invention;

FIG. 2 is a block diagram of a system that includes the power adaptor and the related devices;

FIG. 3 is a perspective view of a power adaptor together with other replaceable charging outlets according to the embodiment;

FIG. 4 is a perspective view of a power adaptor together with other replaceable charging outlets according to another embodiment, showing that a lid is lifted to uncover the mounted charging outlet;

FIG. 5 is a similar to FIG. 4, showing the lid covering the mounted charging outlet;

FIG. 6 is a perspective view of a power adaptor together with other replaceable charging outlets according to yet another embodiment, showing that the mounted charging outlet is rotatable; and

FIG. 7 is a similar to FIG. 6, showing the mounted charging outlet is rotated to a hiding position.

### DETAILED DESCRIPTION OF EMBODIMENTS

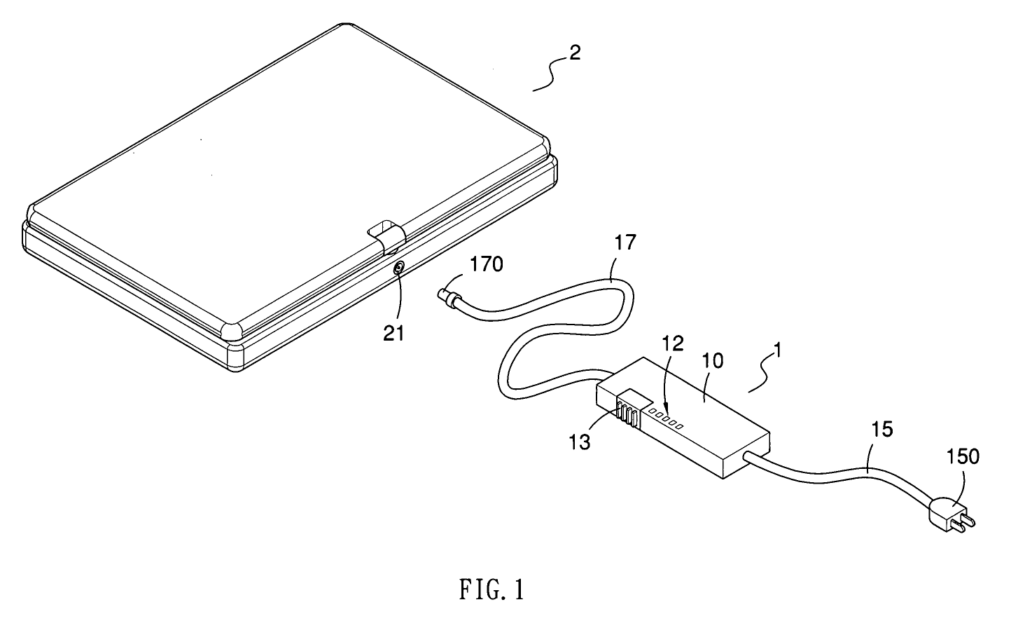

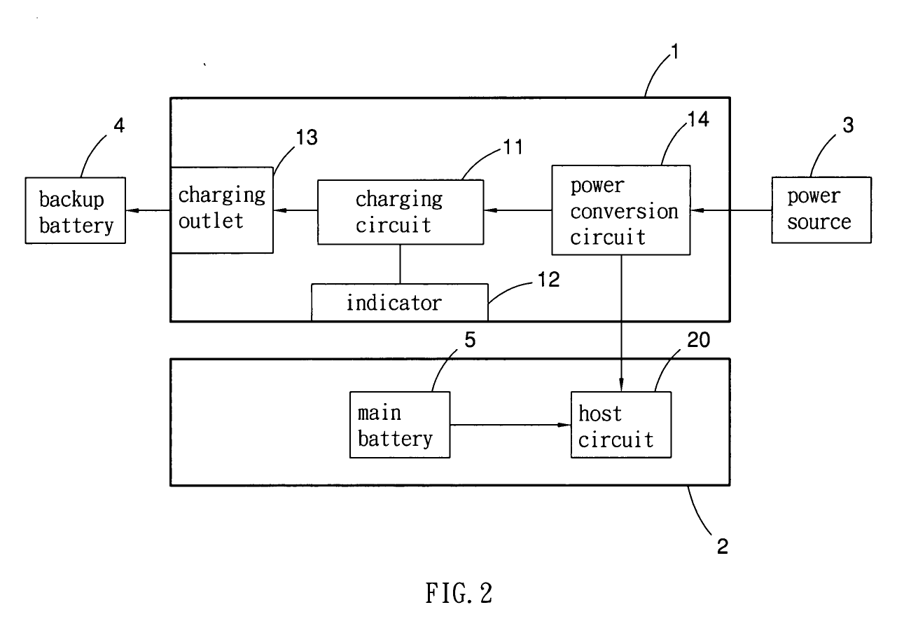

Referring now to FIG. 1 of the drawings, a power adaptor 1 for a portable computer 2 in accordance with one embodiment of the invention includes a housing 10 and a first cord 15 extending from one end of the housing 10, a second cord 17 extending from the other end of the housing 10, a charging outlet 13 mounted at a side of the housing 10 and an indicator 12 mounted next to the charging outlet 13. Referring to FIG. 2, the power adaptor 1 further includes a power conversion circuit 14 and a charging circuit 11 disposed inside the housing 10.

As shown in FIGS. 1 and 2, the first cord 15 has a connector 150 formed at one end thereof for connection with an external power source 3, such as a main power source 3. Similarly, the second cord 17 has a connector 170 for connection with a power input port 21 of the portable computer 2. More specifically, the power conversion circuit 14 has one end connected to the power source 3 via the first cord 15 and the other end connected to a host circuit 20 of the portable computer 2 via the second cord 17. It follows that the power conversion circuit 14 can converse AC power of the power source 3 brought by the first cord 15 into DC power then transmit it to the host circuit 20 of the portable computer 2 via the second cord 17. It is noted that the first and second cords 15, 17 may be undetachably fixed on the opposite ends of the housing 10. Alternatively, the first and second cords 15, 17 may be attached to the housing 10 in a detachable way and therefore be easy to carry and store during travelling.

Referring again to FIG. 2, the charging circuit 11 has one end connected to the power conversion circuit 14 and another end connected to the charging outlet 13 for charging a backup battery 4 which is applied to the portable computer 2 as well. When the backup battery 4 is plugged into the charging outlet 13 of the power adaptor 1, the power conversion circuit 14 can output the conversed power not only to the host circuit 20 of the portable computer 2 but also to the backup battery 4 for charging via the charging circuit 11 and the charging outlet 13. Briefly, a user, with the help of the power conversion circuit 14, can operate the portable computer 2 and charge the backup battery 4 at the same time without the bothersome removal of the main battery 5. By the way, the indicator 12, such as LED light, is linked to the charging circuit 11 to indicate the charging status of the backup battery 4.

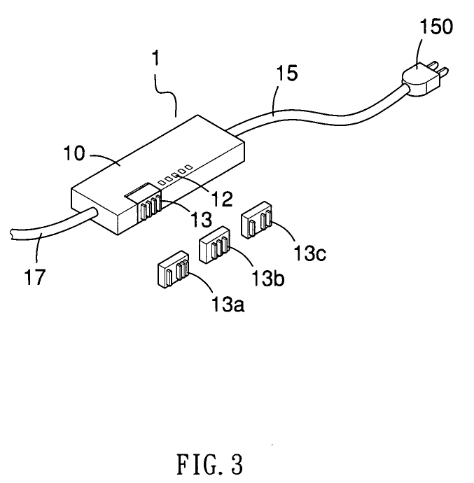

Referring to FIG. 3, the charging outlet 13 of the power adaptor 1 is detachably mounted on the housing 10. As such, the charging outlet 13 is replaceable by another type of charging outlet 13a, 13b or 13c. For example, when the charging outlet 13 is replaced by the charging outlet 13a, a different type of power adaptor is formed. In this way, the different power adaptor can be applied for a suitable portable computer for which the charging outlet 13a is constructed.

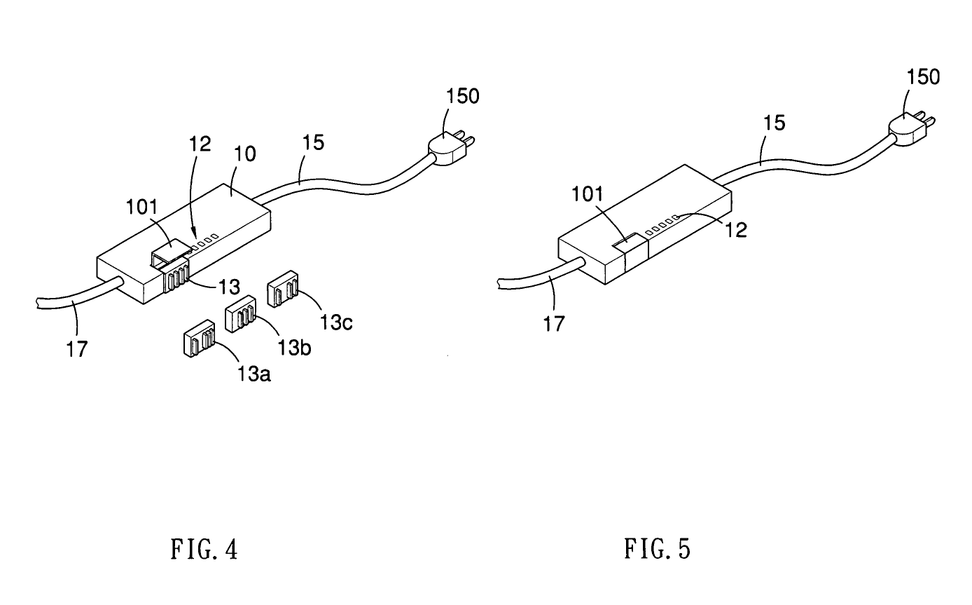

FIG. 4 provides a perspective view of a power adaptor in an alternate embodiment. As with the power adaptor of FIGS. 1-3, however, a liftable lid 101 is mounted on the housing 10. The lid 101 is generally dimensioned in accordance with the charging outlet 13 to cover or uncover the same. In this way, the charging outlet 13, when not in use, can be appropriately covered and protected, as depicted in FIG. 5. Similarly, the charging outlet 13 is detachably mounted on the housing 10 and may be replaced by another type of charging outlet 13a, 13b or 13c for application of a different type of portable computer.

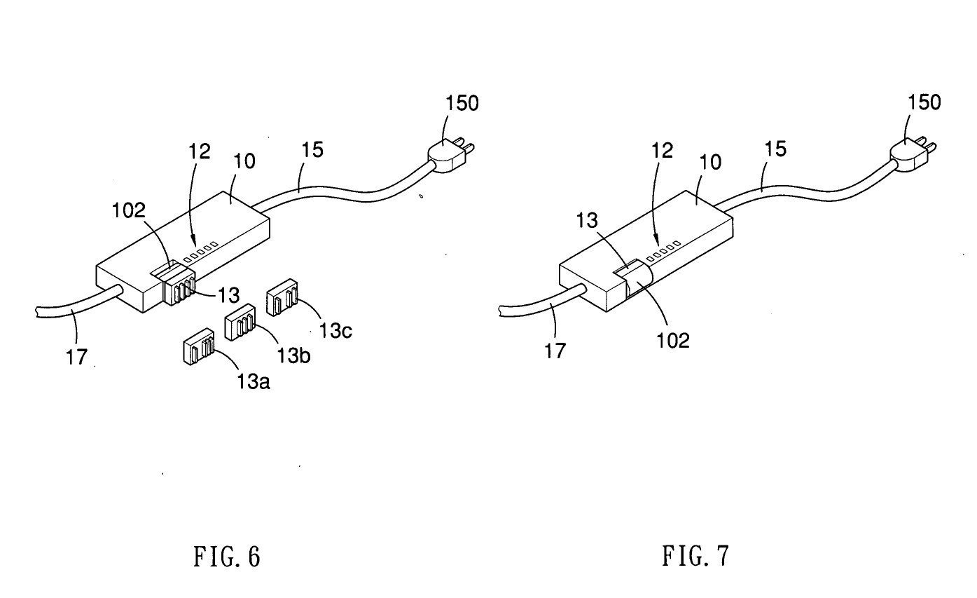

FIG. 6 illustrates a power adaptor in another alternate embodiment. As with the replaceable charging outlet 13 of FIGS. 1-3, the charging outlet 13 of FIG. 6 with the use of a lateral shaft 102 is rotatably mounted on the housing 10. In this way, the charging outlet 13 can be rotated outward, as depicted in FIG. 6, for use. Otherwise, the charging outlet 13 can be rotated inward for hiding itself from outside, as depicted in FIG. 7. Similarly, the charging outlet 13 is detachably mounted on the housing 10 and may be replaced by another type of charging outlet 13a, 13b or 13c for application of a different type of portable computer.

As described above, the present invention enables the portable computer to be powered and the backup battery to be charged at the same time. This is quite convenient for the user. Moreover, configuration of the replaceable charging outlet enables the power adaptor to be fabricated and assembled in a simplified and cost-effective manner.

It will be appreciated that although a particular embodiment of the invention has been shown and described, modifications may be made. It is intended in the claims to cover such modifications which come within the spirit and scope of the invention.

The invention claimed is:

1. A power adaptor for a portable computer, comprising:
a housing;
a first cord extending from said housing and having a connector for connection with an external power source;
a second cord extending from said housing and having a connector for connection with a portable computer;
a power conversion circuit located in said housing and having one end connected to said first cord and the other end connected to the second cord, wherein said power conversion circuit is configured for conversing AC power brought by said first cord into DC power and for transmitting said DC power to said portable computer via said second cord;
a charging circuit located in said housing, connected to said power conversion circuit and configured for charging a backup battery of said portable computer; and
a charging outlet mounted on said housing and linked to said charging circuit for connection with said backup battery.

2. The electrical adaptor of claim 1 further comprising an indicator mounted on said housing; said indicator being connected to said charging circuit to indicate a charging status of said backup battery.

3. The electrical adaptor of claim 1, wherein said charging outlet is detachably mounted on said housing.

4. The electrical adaptor of claim 2, wherein said charging outlet is detachably mounted on said housing.

5. The electrical adaptor of claim 1, wherein said charging outlet is rotatably mounted on said housing.

6. The electrical adaptor of claim 2, wherein said charging outlet is rotatably mounted on said housing.

7. The electrical adaptor of claim 5, wherein said charging outlet is detachably mounted on said housing.

8. The electrical adaptor of claim 6, wherein said charging outlet is detachably mounted on said housing.

9. The electrical adaptor of claim 1, wherein said housing has a liftable lid thereon to cover or uncover said charging outlet.

10. The electrical adaptor of claim 2, wherein said housing has a liftable lid thereon to cover or uncover said charging outlet.

11. The electrical adaptor of claim 9, wherein said charging outlet is detachably mounted on said housing.

12. The electrical adaptor of claim 10, wherein said charging outlet is detachably mounted on said housing.
